(19) United States
(12) Patent Application Publication
(10) Pub. No.: US 2015/0244194 A1
(43) Pub. Date: Aug. 27, 2015

(54) BATTERY CHARGER

(71) Applicant: MAKITA CORPORATION, Anjo-shi (JP)

(72) Inventors: Yasuhiro TABUCHI, Anjo-shi (JP); Hideyuki TAGA, Anjo-shi (JP)

(21) Appl. No.: 14/612,676

(22) Filed: Feb. 3, 2015

(30) Foreign Application Priority Data
Feb. 26, 2014 (JP) 2014-035389

(51) Int. Cl. H02J 7/00

(52) U.S. Cl. CPC H02J 7/0042; H02J 7/0052; H02J 7/0013

(57) ABSTRACT

A battery charger has a case with multiple receptacles where each receptacle is configured to receive a battery. A filter is mounted within the case wherein the filter connects to a power line and is configured to reduce electronic noise. One or more printed circuit boards (PCBs) are mounted within the case and are coupled to corresponding receptacles. The printed circuit boards supply electric current from the power line to charge the batteries and are coupled to an output section of the filter. The PCBs are arranged in parallel to each other. The filter is positioned adjacent to the power line within the case. The battery electrically connects to the PCB via the receptacle by sliding across guide rails on the case.

This application claims priority to Japanese patent application Serial Number 2014-35389, filed on Feb. 26, 2014, the disclosure of which is incorporated in its entirety herein by reference.

### BACKGROUND

1. Field

The present invention generally relates to a charger, such as a portable battery charger. More particularly, embodiments disclosed herein relate to a charger configured to charge at least two batteries simultaneously wherein the batteries may be connected to each other and/or to other various electronic components and/or circuits by one or more battery connecting parts.

2. Background Art

Conventional battery charging devices, such as that disclosed by Japanese Laid-Open Patent Application No. 2013-192282 which relates to a technique for charging a battery to provide a DC power source to an electric power tool, may only charge one battery at a time.

Thus, the above-described charger, and others like it, do not permit for charging multiple batteries simultaneously. As a result, charging more than one battery using such a single-use charger as described above requires replacing a fully charged battery with a depleted battery. This process of continually replacing batteries may take more time than what may be desirable.

In order to address and/or alleviate the concerns associated with such a single-use battery charger as described above, new chargers have been developed to charge more than one battery at a time.

However, charging multiple batteries at once may demand a charging current higher than that otherwise necessary to charge only a single battery. Also, such a large charging current may produce a more significant electrical interference, noise, or distortion. In such a situation, a filter circuit may be applied to and/or integrated with the charger to meet the Electromagnetic Environment Compatibility (EMC) act.

In light of the concerns discussed above, an electrical circuit board with an integrated filter circuit part intended to reduce electrical noise may be built into a charger specially configured to house and charge multiple batteries. However, such an electrical circuit board dedicated to reduce electronic noise may increase manufacturing costs and unwarrantedly increase the relative complexity of charger repair and/or replacement.

In view of the above, there is a need for systems, apparatuses and methods that can charge multiple batteries simultaneously. Furthermore, there is a need to efficiently address the potential noise produced by the increased current associated with charging more than one battery at once.

### SUMMARY

The present invention generally relates to a battery charger. In addition, the present invention relates to a battery charger with a case having multiple receptacles where each receptacle is configured to receive a battery. A filter is mounted within the case wherein the filter connects to a power line and is configured to reduce electronic noise. One or more printed circuit boards (PCBs) are mounted within the case and are coupled to corresponding receptacles. The printed circuit boards supply electric current from the power line to charge the batteries and are coupled to an output section of the filter. The PCBs are arranged in parallel to each other. The filter is positioned adjacent to the power line within the case. The battery electrically connects to the PCB via the receptacle by sliding across guide rails on the case.

In an embodiment, the filter is positioned adjacent to the power line within the case.

In an embodiment, the filter and the PCB are attached to a bottom surface of the case.

In an embodiment, the charger has a rib positioned within the case to control electronic noise associated with the PCB.

In an embodiment, the charger has a constant voltage PCB mounted within the case wherein the constant voltage PCB outputs a constant voltage and further wherein the constant voltage PCB is electrically coupled to an output section of the filter PCB.

In an embodiment, the charger has a PCB is mounted within the case in a direction substantially perpendicular to a bottom surface of the case.

In an embodiment, the charger has one or more PCBs positioned in a sequence within the case.

In an embodiment, the battery electrically connects to the PCB via the receptacle by sliding across guide rails on the case.

It is, therefore, an advantage of the present invention to provide a battery charger capable of charging multiple batteries simultaneously.

A further advantage of the present invention is to provide a sliding rail along which the battery may slide to insert into the receptacle.

And, another advantage of the present invention is to provide a battery charger with a case shaped substantially as a rectangle.

Still further, an advantage of the present invention is to provide a filter is mounted within the case wherein the filter connects to a power line and is configured to reduce electronic noise.

Yet another advantage of the present invention is to position one or more receptacles on the case for even shape distribution and/or weight distribution across the battery charger.

Still further, an advantage of the present invention is to provide a printed circuit board (PCB) that may be used in single battery charge applications as well as multiple battery charge applications.

Yet another advantage of the present invention is to reduce manufacturing costs by providing a PCB capable of use in both single battery charging and multiple battery charging applications.

Moreover, an advantage of the present invention is to provide a method of using the battery charger to charge multiple batteries simultaneously.

Additional features and advantages of the present invention are described in, and will be apparent from, the detailed description of the presently preferred embodiments and from the drawings.

### BRIEF DESCRIPTION OF THE DRAWINGS

FIG. 1 illustrates an overall perspective view of a charger in accordance with an embodiment of the present invention.

FIG. 2 illustrates a plan view of the inside of a housing of the charger showing an arrangement of printed circuit boards for mounting a filter and charging a battery in accordance with an embodiment of the present invention.

FIG. 3 illustrates a perspective view showing the inside of the housing in accordance with an embodiment of the present invention.

FIG. 4 illustrates a block diagram of the charger in accordance with the embodiment of the present invention.

FIG. 5 illustrates a schematic diagram of the filter circuit located on the printed circuit board for mounting the filter in accordance with an embodiment of the present invention.

FIG. 6 illustrates a schematic diagram of the battery and the charging circuit located on the printed circuit board for charging the battery in accordance with an embodiment of the present invention.

FIG. 7 illustrates a plan view of a charger in a prior art where only one battery can be charged in accordance with an embodiment of the present invention.

FIG. 8 illustrates a plan view showing an arrangement of a printed circuit board for charging a battery where only one battery can be charged in accordance with an embodiment of the present invention.

### DETAILED DESCRIPTION

The detailed description set forth below in connection with the appended drawings is intended as a description of exemplary embodiments of the present invention and is not intended to be restrictive and/or to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures, components and/or devices are shown in block diagram form in order to avoid obscuring the novelty of the exemplary embodiments presented herein.

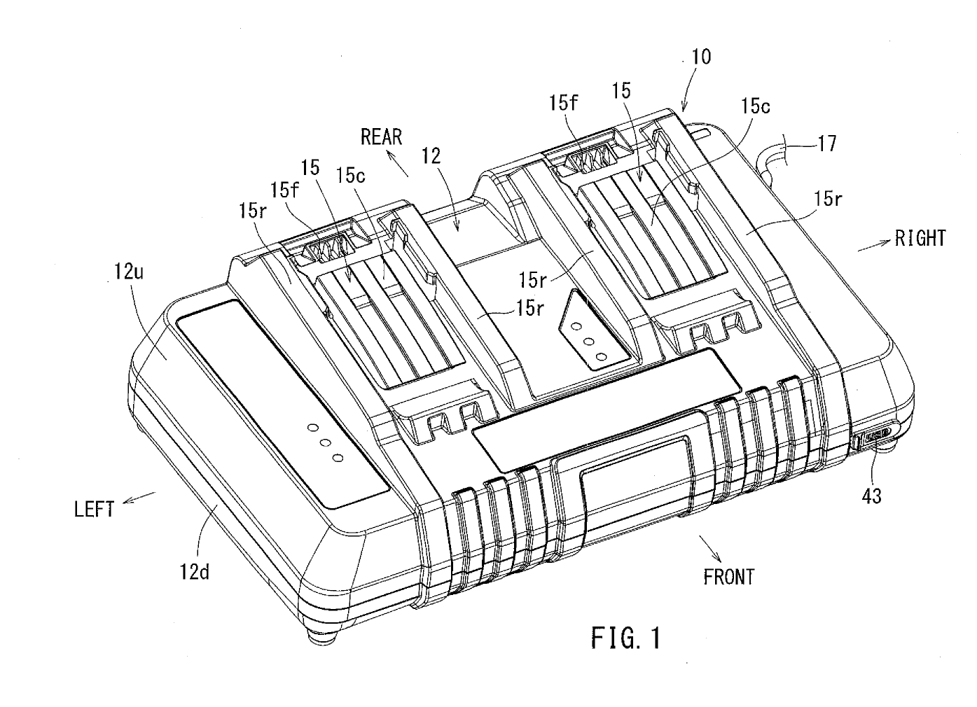

Referring now to the drawings wherein like numerals refer to like parts, FIGS. 1-8 generally illustrate a charger 10 in accordance with embodiments of the present invention. The charger 10 may be configured to simultaneously charge two batteries 50 that may provide power to, for example, an electric power tool.

Terms such as “front,” “rear,” “left,” and/or “right” as used in the description below to indicate position, orientation and/or direction may be relative to the position of the charger.

As shown in FIG. 1, the charger 10 may have a case 12 generally constructed in the shape of a rectangular box. The case 12 may close and/or form a sealed enclosure upon the insertion and/or attachment of an upper case part 12u into a corresponding lower case part 12d. Further, the upper case part 12u may include raised and/or angled receptacles 15 configured to connect the case 12 of the charger 10 to the batteries 50 (not shown in the FIGS.).

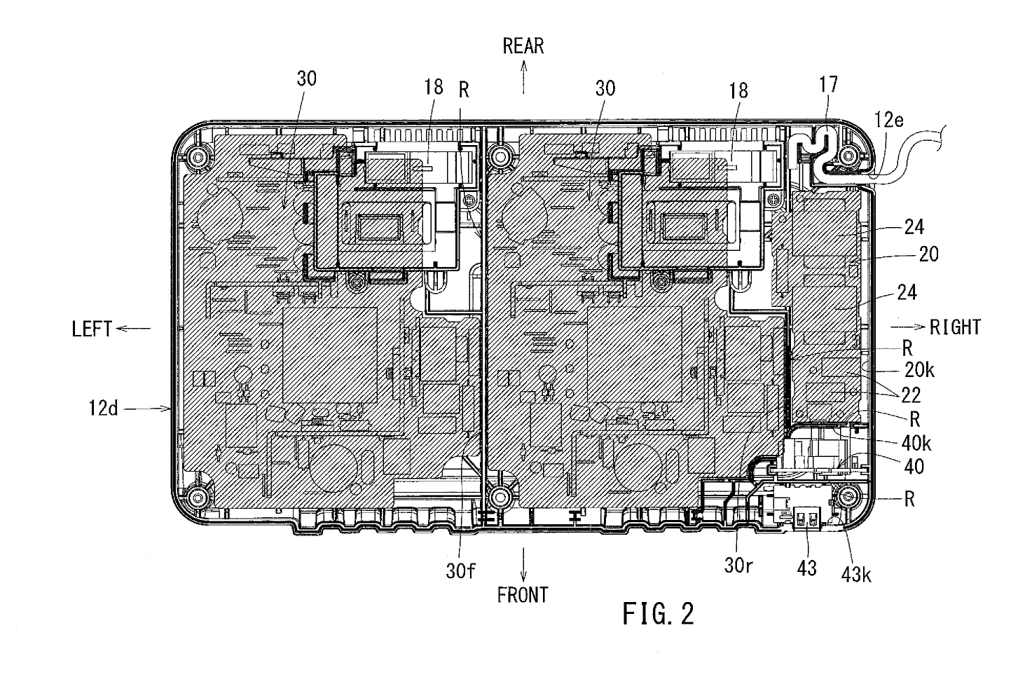

A power line 17 may extend from the case 12 to connect the charger 10 to a wall-socket associated with a power source, such as a commercial and/or industrial alternating current (“AC”) power source (not shown in the FIGS.). In detail, as shown in FIG. 2, an opening 12e near the rear right end of the case 12 may receive an end of the power line 17. The power line 17 may connect and/or couple with various electronic circuitry associated with the case 12 and/or charger 10 to supply electrical power to the batteries (not shown in the FIGS.)

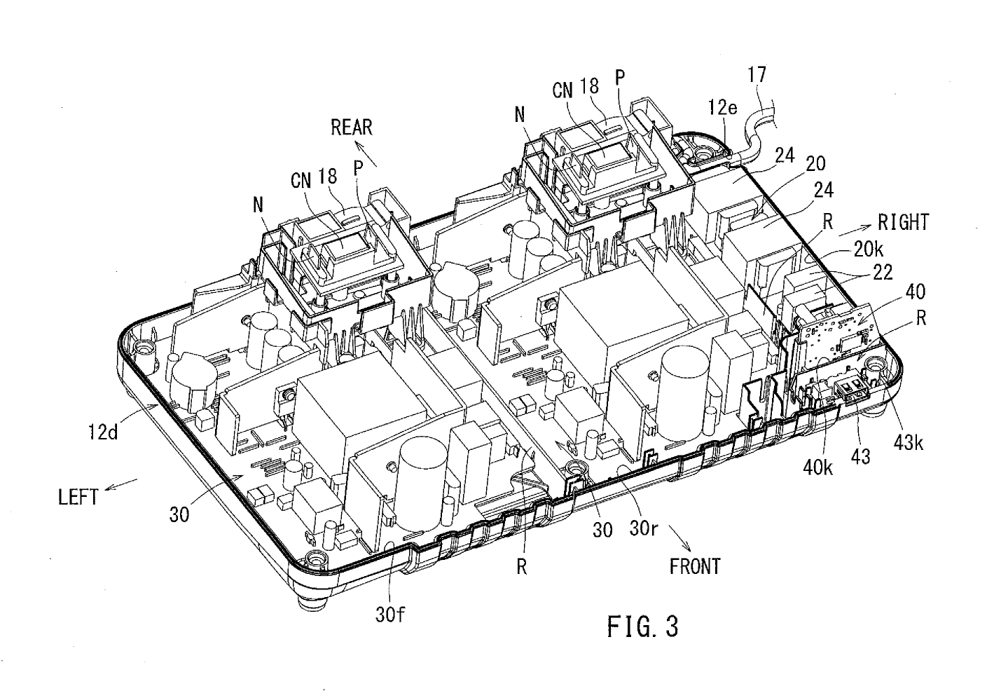

As shown in FIGS. 2 through 4, the case 12 of the charger 10 may enclose a printed circuit board (referred to as a “PCB” herein) 20 attached and/or coupled to the lower case part 12d. A pair of PCB 30 may be placed adjacent to the PCB 20 and may be configured to accommodate charging circuits (referred to as “charging PCBs” herein). Further, a PCB 40, such as a constant voltage output circuit (referred to as a “USB PCB” herein), may be positioned perpendicular to the pair of PCB 30 as shown in, for example, FIGS. 2 and 3. A ventilation fan 18 may be located toward a rear of the case 12 of the charger 10 to, for example, circulate air to cool the battery 50 (not shown in the FIGS.) attached to the receptacle 15.

As shown in FIGS. 2 and 3, ribs R, which may be positioned perpendicular to the PCB 30, may form separate compartments. The ribs R may be formed from, for example, resin, insulation materials and/or any combination of the same. On the right end of the case 12, a compartment 20k for the filter PCB 20 extending in the front-rear direction may be defined on the front side of the opening 12e by the rib R. Further, the filter PCB 20 may be housed in the compartment 20k in a direction substantially parallel with the bottom surface of the case 12 and attached to the case 12.

The rib R positioned by the right end of the case 12 may define a compartment 40k for a USB PCB. Similarly, other ribs R may define other compartments, such as 20k for filter PCB 20. Further, as shown in FIG. 3, the PCB 40 may be positioned within the compartment 40k to be substantially perpendicular to and attached to the bottom surface of the case 12. Further, a compartment 43k for case a USB connector 43 may be formed on the front side of the compartment 40k.

As shown in FIGS. 2 and 3, a rib R may bisect the case 12 into a left side compartment 30f and a right side compartment 30r, when viewed from the front. Both compartments 30f and 30r may have a generally rectangular and/or square shape. The right side PCB 30 and the left side PCB 30 may be attached to the case 12 and be housed in the compartment 30r and the compartment 30f, respectively, in a direction parallel with the bottom surface of the case 12. Due to the configuration and/or positioning of the PCB 30 as described above, the various ribs R, made from, for example, resin, may partition the PCBs 20, 30 and 40 which may be housed in the compartments 20k, 30r, 30f and 40k, respectively. Further, the compartments may isolate the PCBs 20, 30 and 40 to prevent against unwanted signal interference that may be produced by positioning the PCBs in close proximity to one another. Thus, the compartments may allow for the PCBs to be positioned and/or arranged at a specific clearance and/or creepage distance apart, for example.

Referring generally now to FIG. 3, two ventilation fans 18 may be positioned toward the rear of the case 12, with one fan located to the left and right of the rib R that spans the length of the case 12. The ventilation fans 18, once activated, may circulate air to cool the battery 50 (not shown in the FIGS.) attached to the receptacle 15.

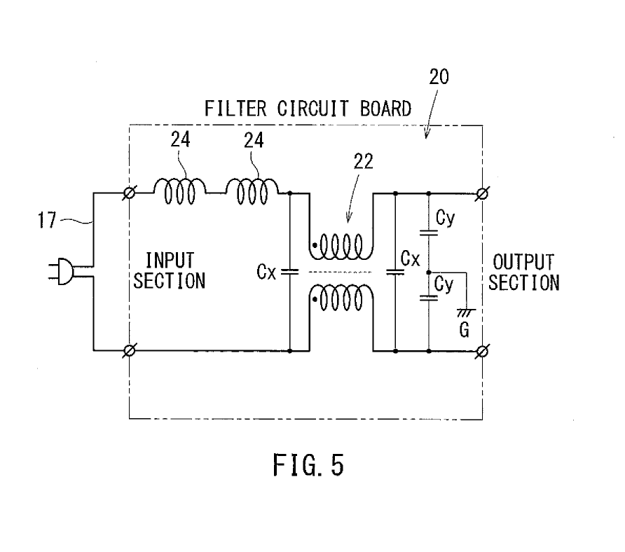

A filter (not shown in the FIGS.) associated with PCB 20 may have a rectangular shape and include a filter circuit for reducing electrical noise and/or interference. The filter may reduce conduction noises such as a differential mode noise and/or common mode noise that may pass through the power line. Also, the filter may suppress magnitude of a harmonic current associated with the filer circuit to or below a predetermined limit value. In detail, a filter associated with PCB 20 may have, as shown in FIG. 5, an X capacitor for reducing differential mode noise, a common mode filter 22 also for reducing common mode noise, and a Y capacitor Cy for releasing harmonic common mode noise to the ground. The filter PCB 20 may also have a choke coil for suppressing the magnitude of the harmonic current to or below a predetermined limit value.

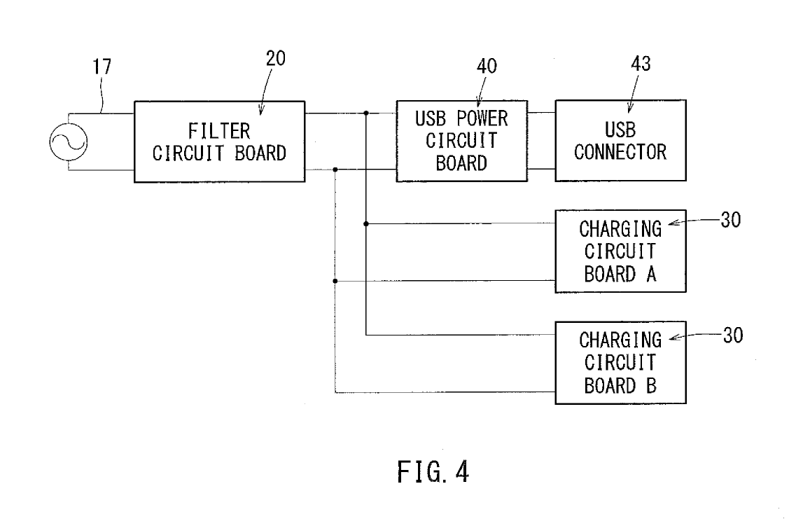

Referring now to FIGS. 4 and 5, the power line 17 of the charger 10 may be connected to an input section of the filter PCB 20. Further, as shown in FIG. 4, an output section of a filter associated with the PCB 20 may connect to the PCBs 30, that may be charging PCBs, and the USB PCB 40. The left PCB 30, the right PCB 30, and the USB PCB 40 may be connected in parallel to each other.

As described above, a filter associated with the PCB 20 may be housed in the compartment 20k near the opening 12e for passing the power line 17. Owing to this, the power line 17 arranged in the case 12, which may be pulled in into the case 12 from the opening 12e and connected to the filter PCB 20, may be shortened as much as possible. As a result, the power line 17 may enter the case 12 through the opening 12e and immediately connect to a filter associated with the PCB 20. Given the close proximity of the filter with the opening 12e, a long power line 17 may not be needed, thus also reducing and/or minimizing potential exposure of the power line 17 to electrical interference and/or noise produced by the PCBs 30.

Each of the PCBs 30 may have a charging circuit for charging the battery 50 that may be electrically connected to the receptacle 15 of the case 12. The PCBs 30, as shown in FIGS. 1-3, may also be applied in a charger 60 configured to charge, for example, a single battery at a time as shown in FIG. 8.

As described above, the PCBs 30 may be formed to be in a generally rectangular and/or square shape to correspond with the size of the compartments 30f and 30r. Further, as shown in FIG. 2 for example, the PCBs 30 may also have regions configured to accommodate various electronic circuits and components installed in the case 12.

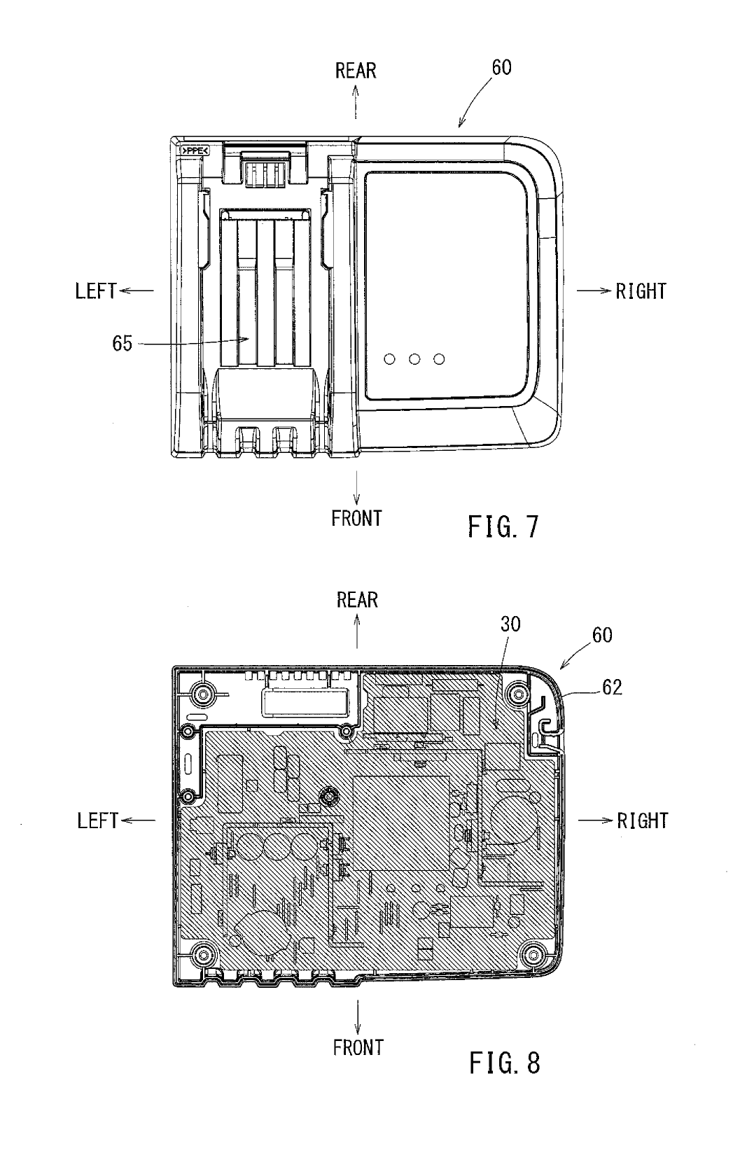

As shown in FIG. 2, the right and left charging PCBs 30 may be attached to the housing 12 such that one of the long sides thereof may face each other and each of the short sides thereof may be positioned on the same line. In other words, the length of the aligned PCBs 30 in the front-rear direction may be equal to that of the long side of the one PCB for charging only one battery, and the length in the right-left direction may be substantially double to that of the short side thereof. Because of this, when aligning two charging PCBs, a length in the front-rear direction may not be so large compared to that in the right-left direction, and thus a shape distribution may be obtained in terms of the lengths between the two directions. In other words, the configuration will be explained as follows. As shown in FIG. 2, the PCBs 30 may be inserted into and/or positioned in parallel within the case. Each of the PCBs 30 may have a defined length from the front to rear. Further, the PCBs 30 having a defined length may be applied in either the charger 10, as shown in FIGS. 1-3, or the charger 60, as shown in FIGS. 7-8. In detail, the PCBs 30 may be sized to generally correspond with the shape and/or size of the charger 10 or the charger 60. In an embodiment as shown by FIGS. 1-3, the charger 10 may have front side, a rear side parallel to the front side, and right and left sides perpendicular to the front and rear sides to form a rectangular box, for example. Each of the front and rear sides may be longer than, for example twice the length of, a left and a right side. Accordingly, the elongated shape of the charger 10 as described here may allow for side-by-side battery charging, as shown in FIGS. 1-3, and even shape distribution and/or weight distribution of the batteries 50 (not shown in the FIGS.).

In an embodiment as shown in FIGS. 7-8, the PCB 30 may be sized appropriately to correspond with the shape and/or structure of the charger 60. Further, the charger 60 may have longer left and right sides than front and rear sides to be formed generally as a rectangular box. A receptacle 65 may be positioned off-center on the charger 60, as shown in FIG. 7, to allow for even shape distribution and/or weight distribution across the charger 60. Also, the receptacle 65, as shown in FIG. 7, may be the same as and/or equivalent to the receptacle 15, as shown in FIG. 1, such that either receptacle 65 or 15 may be used interchangeably with the chargers 10 or 60.

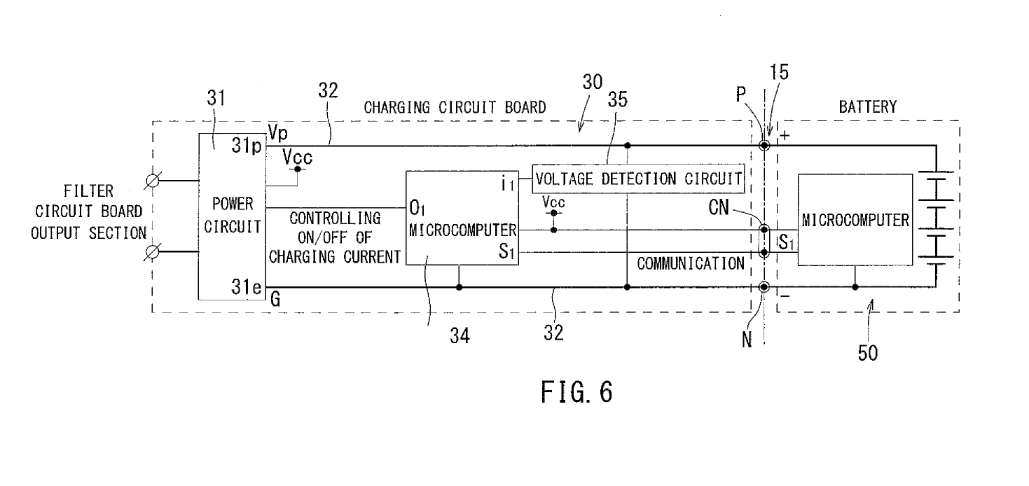

Referring now to FIG. 2, the PCBs 30 to the left and right of the rib R (that extends from the front to the rear of the case) may connect to and/or couple with the receptacles 15 positioned generally above the corresponding PCBs 30. Accordingly, one or more batteries 50 (not shown in the FIGS.) may be inserted into either the left side receptacle 15 and/or the right side receptacle 15 to be charged by the corresponding PCB 30 positioned beneath the receptacle 15. For example, the left side PCB 30 may charge the battery 50 inserted into the left side receptacle 15. In detail, each of the PCBs 30 may have at least, as shown in FIG. 6, a power circuit 31, a microcomputer 34, and/or voltage detection circuit 35, among other similar electronic parts. Further, as shown in FIGS. 4 and 6, electric power may be supplied from an output of a filter associated with PCB 20 to the power circuit 31.

Referring now to FIG. 6, the power circuit 31 may convert AC power to a DC power (Vp) used for charging the batteries 50 and/or a DC power (Vcc) used for controlling the microcomputer 34, etc. As shown in FIG. 6, the power circuit 31 may have output terminals 31p and 31e (Vp or ground) used for charging the batteries. Further, the output terminals 31p and 31e may be connected to a positive terminal P and a negative terminal N located in the receptacle 15 by use of electric wires 32.

The microcomputer 34 may control the battery 50 in accordance with an output signal from the voltage detection circuit 35. In detail, the microcomputer 34 may be configured to output either an ON or OFF instruction signal for charging the battery from an output terminal O1 to the power circuit 31. Further, the microcomputer 34 may include a communication terminal S1 connected to a connector CN (not shown in the FIGS.) located in the receptacle 15 via a communication cable.

The receptacle 15 for receiving and/or connecting to the battery 50 may have, as shown in FIG. 1, guide rails 15r on each side thereof for guiding the battery 50 in a sliding manner in the front-rear direction. Circulated air from the ventilation fan 18 may escape the interior of the case 12 through an exhaust port 15f located between the guide rails 15r. A terminal cover 15c may also be placed in between the guide rails 15r and may slide in the front to rear direction. Now referring to FIG. 3, the positive terminal P, the negative terminal N, and the communication terminal CN may be located in an area of the case 12 where the receptacle 15 is covered with the terminal cover.

Upon insertion into the receptacle 15, the battery 50 (not shown in the FIGS.) may contact and push the terminal cover 15c in the forward direction toward the front of the charger 10. Movement of the terminal cover 15c may expose, as shown in FIG. 3, a positive terminal P, a negative terminal N, and a connector CN which may all connect to corresponding terminals and/or connectors of the battery as shown in FIG. 6.

Methods to operate the charger 10 will be described next.

Before charging two batteries 50 at a time by use of the charger 10, the batteries 50 may be connected to the right receptacle 15 and the left receptacle 15, respectively. One or more batteries 50 may be inserted into and/or connect with the left and/or right receptacle 15. Once the connection between the battery 50 and the charger 10 is established and/or confirmed by the microcomputer 34, the microcomputer 34 may begin charging the battery 50. In detail, a microcomputer 34 mounted on the right and left PCBs 30 may activate a corresponding power circuit 31 for charging the batteries 50. To charge both batteries 50 simultaneously, charging current flowing through the power circuit may be appropriately increased. Accordingly, electronic interference and/or noise may also proportionately increase along with the additional charging current. A filter associated with the PCB 20 may remove and/or filter such noise. The microcomputer 34 may detect a predetermined condition to deactivate the power circuit 31 to complete charging the battery 50.

As discussed earlier, the charger 10, as shown in FIGS. 1-3, may charge two batteries 50 (not shown in the FIGS.) simultaneously. The charger 10 may be configured to have two PCBs 30 with identical specifications. The PCBs 30 may connect to the left receptacle 15 and the right receptacle 15 to supply current to and charge the batteries 50. Similarly, the charger 60, as shown in FIGS. 7 and 8, may use a single PCB 30 to charge a single battery 50 at a time. As discussed earlier, the PCB 30 may be used in the charger 10 as well as the charger 60.

Additionally, a malfunctioning PCB 30 may be removed and replaced with a new PCB 30.

Also, as discussed earlier, the electronic interference and/or noise produced by the additional electric current needed to charge two batteries at once may be reduced by a filter associated with the PCBs, such as PCB 20.

As discussed earlier, the filter PCB 20 may be positioned near an area where the power line 17 is pulled into the case 12 of the charger 10. As a result, the length of the power line 17 housed within the case 12 may be minimized to reduce potential electronic interference and/or noise produced by the PCBs 30.

As described above, ribs R made from, for example, resin, may be positioned in between and/or near the various PCBs. Accordingly, due to the configuration of the ribs R in proximity to the PCBs as described, a necessary isolation distance may be established even if the distance between the PCBs is relatively short. Also, the configuration may allow for a sufficient creepage distance between the PCBs.

Further, since the USB PCB 40 may be electrically connected to an output section of a filter associated with PCB 20, noise currents emitted from the USB PCB 30 may be reduced.

Also, the USB PCB 40 may be positioned vertically to take up a minimal amount of floor space on the case 12.

As discussed earlier, the rectangular shape of the charger 10 may allow for the batteries 50 (not shown in the FIGS.) to be placed side-by-side, thus allowing for even shape distribution and/or weight distribution across the charger.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

What is claimed is:

1. A charger, comprising:
a case with a receptacle configured to receive a battery;
a filter mounted within the case wherein the filter connects to a power line and is configured to reduce electronic noise; and
a printed circuit board (PCB) mounted within the case and coupled to the receptacle wherein the printed circuit board supplies electric current from the power line to charge the battery and farther wherein the printed circuit board is coupled to the filter,
wherein more than one PCBs are positioned in parallel to each other within the case and further wherein the PCBs have identical specifications.

2. The charger of claim 1, wherein the filter is positioned adjacent to the power line within the case.

3. The charger of claim 1, wherein the filter and the PCB are attached to a bottom surface of the case.

4. The charger of claim 1, further comprising:
a rib positioned within the case to control electronic noise associated with the PCB.

5. The charger of claim 1, further comprising:
a constant voltage PCB mounted within the case wherein the constant voltage PCB outputs a constant voltage and further wherein the constant voltage PCB is electrically coupled to an output section of the filter.

6. The charger of claim 5, wherein the constant voltage PCB is mounted within the case in a direction substantially perpendicular to a bottom surface of the case.

7. The charger of claim 1, wherein the PCBs can be applied in a charger configured to charge a single battery.

8. The charger of claim 1, wherein the battery electrically connects to the PCB via the receptacle by sliding across guide rails on the case.

9. The charger of claim 8, wherein the PCBs have a substantially rectangular shape with long sides and short sides and further wherein the PCBs are mounted in the case such that the short sides of each of the PCBs are positioned on the same line and further wherein the sliding direction of the battery is substantially parallel with the long sides of the PCBs.
